(19) United States
(12) Patent Application Publication
(10) Pub. No.: US 2014/0285860 A1
(43) Pub. Date: Sep. 25, 2014

(54) MEDIA LIFT DEVICE

(71) Applicant: HEWLETT-PACKARD DEVELOPMENT COMPANY, L.P., Houston, TX (US)

(72) Inventor: Dean J. Richtsmeier, Boise, ID (US)

(21) Appl. No.: 14/241,768

(22) PCT Filed: Sep. 21, 2011
(86) PCT No.: PCT/US2011/052445

§ 371 Date: Feb. 27, 2014

(51) Int. Cl. H04N 1/00; H04N 1/10

(52) U.S. Cl. CPC H04N 1/00631; H04N 1/1061; H04N 1/00591; H04N 2201/0081
USPC 358/497; 427/207.1

(57) ABSTRACT

A scanner having at least one media lift device is disclosed. The scanner has a transparent scanning platen with a flat to surface. The media left device is bonded to the flat top surface. The media lift device forms a raised area on the top of the flat surf and wets the transparent scanning platen.

### BACKGROUND

Many scanners use an automatic document feeder (ADF) to feed documents into the device. The scanners may be stand alone scanners or may be combined with other devices, for example FAX machines, primers or MFPs. The ADF typically moves each page in the document across a flat piece of glass that has a scanning head underneath the glass. Once the paper passes across the glass the leading or front edge of the paper must be lifted away from the glass surface so that the page can be directed into the output bin of the device.

Typically one or more ramps are positioned along the surface of the glass to lift the page away from the glass surface. Lifting the front edge of the paper away from the glass is difficult because the paper can be quite thin, The thin edge of the paper can hit and catch on the end of the ramp, or even fit between the bottom surface of the ramp and the top surface of the glass. Some scanners have a thin transparent sheet, for example polyester, between the paper and the top surface of the glass. Unfortunately, the thin transparent sheet can become dirty or scratched, causing image quality problems for the scanner.

### BRIEF DESCRIPTION OF THE DRAWINGS

FIG. 1 is an isometric top view of a scanner 100 in an example embodiment of the invention.

FIG. 2A is a partial sectional view of scanner 100 in an example embodiment of the invention.

FIG. 2B is a partial sectional view of scanner 100 from FIG. 2A with the addition of ADF output ramps 216, in an example embodiment of the invention.

FIG. 2C is an isometric top view of the scanner 100 from FIG. 2A with the addition of ADF output ramps 216, in an example embodiment of the invention.

FIG. 3 is a side view of a media lift device 300, in an example embodiment of the invention.

FIG. 4 is an isometric top view of a scanner glass with a media lift device formed on the top surface in an example embodiment of the invention.

FIG. 5 is an isometric cross sectional view of a seamier glass with ADF output ramps positioned on the top surface of the scanner glass in an example embodiment of the invention.

### DETAILED DESCRIPTION

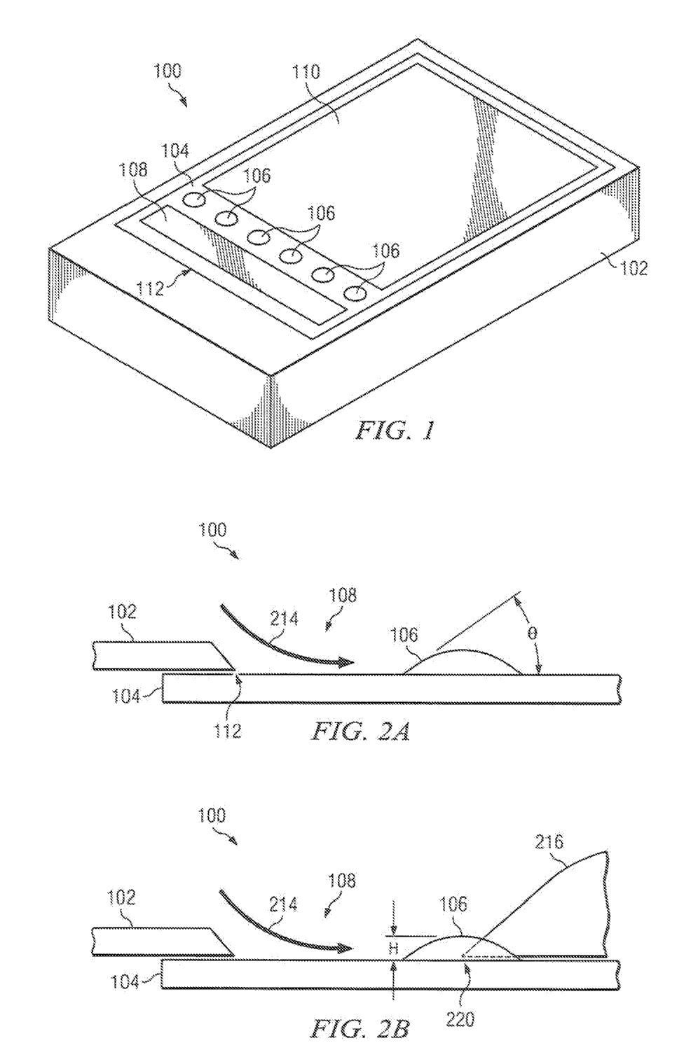

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

In one example embodiment of the invention, one or more media lift devices will be formed or bonded on the top surface of the scanner glass. The media lifting devices form a raised area on the top of the flat surface of the scanner glass. The media lift devices may be in the shape of a dot or bump. The dots or bumps will have a small contact angle that will lift the paper edge off the surface of the glass. The bumps can be formed from a number of materials, for example epoxy, glue, acrylic, glass, wax, or the like. In another example embodiment of the invention, the bumps will be replaced with one or more long beads.

FIG. 1 is an isometric top view of a scanner 100 in an example embodiment of the invention. Scanner 100 comprises top cover 102 and scanner glass 104. Scanner glass 104 may be a single sheet of glass used for both flatbed scans and ADF scans. Area 110 shown on scanner glass 104 is the flatbed scan area and area 108 on scanner glass 104 is the ADF scan area. For clarity, both scanner areas are shown as ending inside the edges of the scanner glass, but in reality both scanner areas may reach to one or more edges of the scanner glass. A plurality of media lift devices 106 are located along the top side of scanner glass between the two scan areas.

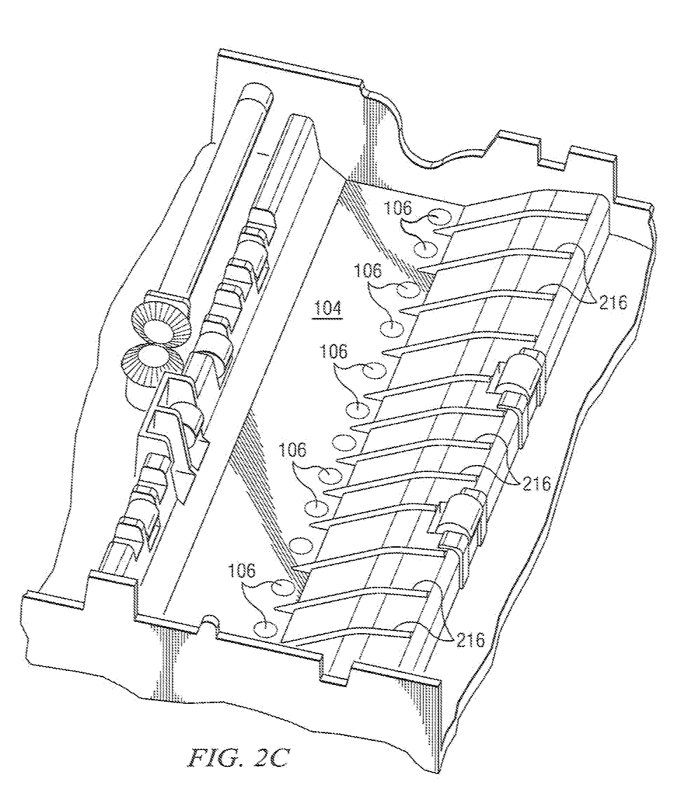

FIG. 2A is a partial sectional view of scanner 100 in an example embodiment of the invention. FIG. 2A shows a segment of scanner glass 104 held against the underside of top cover 102, One of the plurality of media lift devices 106 is shown on the top side of scanner glass 104. The media lift device 106 wets the scanner glass creating a small contact angle θ between the media lift device 106 and the top of the scanner glass 104. The ADF scanning area 108 is between the media lift device 106 and the edge 112 of the top cover 102. When doing an ADF scan, a sheet of media would be moved across the top of scanner glass 104 through ADF scanning area 108 as shown by arrow 214. When the leading edge of the media reaches the media lift device, the leading edge of the media is lifted away from the top surface of the scanner glass 104. In this application, media can be any type of material used to print a document onto, for example paper, transparencies, or the like.

In this example embodiment of the invention, each of the media lift devices 106 are comprised of one or more drops of glue or adhesive bonded to the top surface of the scanner glass 104. The uncured viscosity of the glue or adhesive is chosen such that the contact angle θ is small. Because the contact angle θ is small, the leading edge of the media will not catch on the media lift device. Any type of glue or adhesive may be used to form the media lift devices, for example epoxy, acrylic, cyanoacrylate, or the like. The glue or adhesive may be chemically cured, for example a two part epoxy, UV cured, or the like.

The contact angle θ is the angle at which the liquid-vapor interface meets the solid-liquid interface. The contact angle is determined by the resultant between adhesive and cohesive forces. As the tendency of a drop to spread out over a flat, solid surface increases, the contact angle θ decreases. Thus, the contact angle provides an inverse measure of wettability. Wetting is the ability of a liquid to maintain contact with a solid surface, resulting from intermolecular interactions when the two are brought together. The degree of wetting (wettability) is determined by a force balance between adhesive and cohesive forces. In general, the wettability of fluids is inversely related to the viscosity of the fluid. In one example embodiment of the invention, the glue or adhesive used to create the media lift devices will have an uncured viscosity between 1000 and 5000 centipoise. In other example embodiment of the invention, the glue or adhesive used to create the media lift devices will have an uncured viscosity between 500 and 9000 centipoise. A drop of liquid that wets a surface typically forms a truncated sphere or a round dot on the surface. The shape may also be described as a bump on the surface.

FIG. 2B is the partial sectional view of scanner 100 from FIG. 2A with the addition of ADF output ramps 216, in an example embodiment of the invention. ADF output ramps are part of the output path of an ADF that can be attached to scanner 100 (The ADF is not shown for clarity). The ADF attaches to the top side of scanner top cover 102. When the ADF is in the down position, ADF output ramps 216 rest on the top surface of the scanner glass 104. The ADF output ramps 216 are positioned between the plurality of media lift devices 106. FIG. 2C is an isometric top view of the ADF output ramps 216 positioned between the plurality of media lift devices 106, in an example embodiment of the invention. The tips 220 of the ADF output ramps 216 are positioned such that the top surface of the media lift devices are above the ADP output ramp tips 220 (see FIG. 28).

As media is moved past the ADF scan area (shown by arrow 214) the edge of the media will contact the media lift device 106. The media lift device will lift the edge of the media away from the top of the glass surface and direct the media edge onto the ADF output ramps 216. The ADF output ramps 216 will then direct the media into the output bin of the ADF. The media lift devices have a height H above the scanner glass. The media lift devices 106 lifts the media away from the top surface of the scanner glass by distance H. This allows the tips 220 of the ADF output ramps 216 to have larger manufacturing and alignment tolerances to the top surface of the scanner glass.

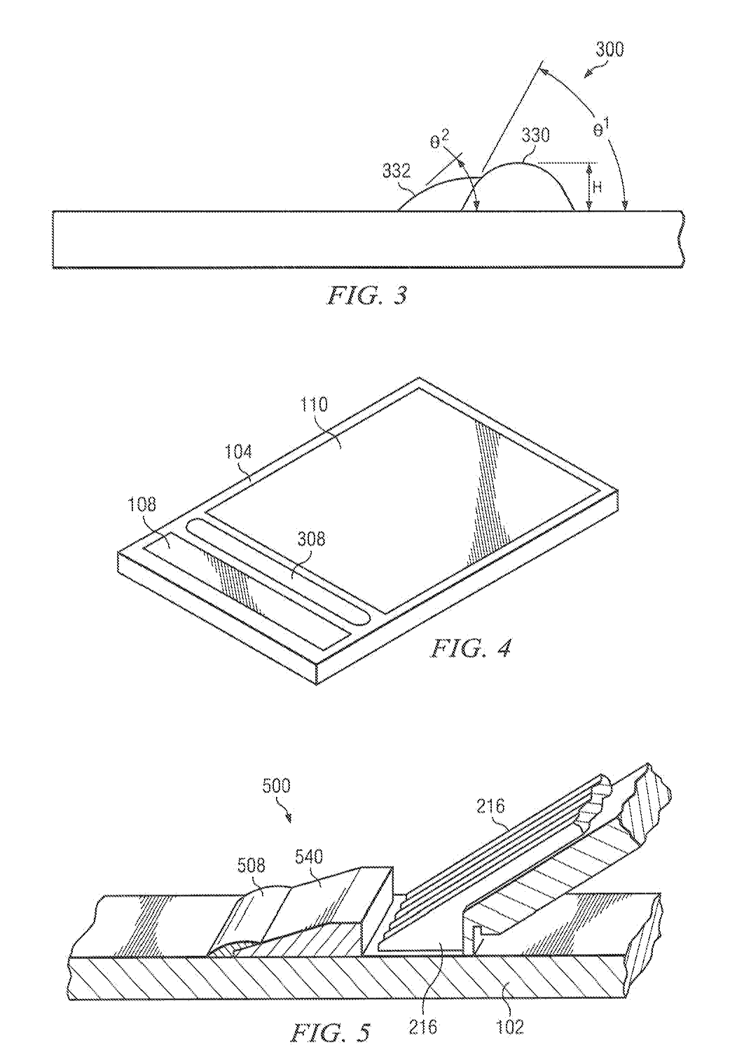

In one example embodiment of the invention, the height of the media lift devices may be increased, by using more than one type of adhesive or glue. For example, a first adhesive with a higher viscosity, and a correspondingly larger contact angle, may be used with a second adhesive with a lower viscosity, and a correspondingly smaller contact angle. FIG. 3 is a side view of a media lift device 300, in an example embodiment of the invention. Media lift device 300 comprises one or more drops of a first glue or adhesive 330 and one or more drops of a second glue or adhesive 332. The first glue or adhesive is applied and cured to the top of the scanner glass and then the second glue or adhesive is applied and cured at the junction of the first glue and the top of the scanner glass. The first glue or adhesive has a first viscosity forming a contact angle θ2 θ1. The second glue or adhesive has a second lower viscosity forming a contact angle 02 where the first contact angle is larger than the second contact angle. Using this arrangement, the small contact angle of a lower viscosity adhesive can be used with the greater height of a higher viscosity adhesive.

In another example embodiment of the invention, the plurality of media lift devices formed as dots or bumps on the top surface of the scanner glass may be replaced with a long bead of glue of adhesive. FIG. 4 is an isometric top view of a scanner glass with a media lift device formed on the top surface. Scanner glass 104 has an ADF scan area 108 and a flatbed scan area 110. In between the two scan areas is media lift device 308. Media lift device 308 is a long bead of adhesive located between the two scanning areas. Except at the very ends of the media lift device, the cross section of the media lift device 308 is in the shape of a truncated cylinder. The adhesive used for the media lift device 308 is chosen such that the contact angle would be small. When an ADF is in the closed position, the ADF output ramps would be positioned behind the media lift device 308 with the media lift device between the ADF output ramps and the ADF scan area.

In another example embodiment of the invention, the media lilt device may be combined with a calibration, strip. FIG. 5 is an isometric cross sectional view of a scanner glass with ADF output ramps positioned on the top surface of the scanner glass. Scanner glass 102 has a media lift device 500 attached to its top surface. Media lift device comprises calibration strip 540 and adhesive bead 508. Calibration strip 540 may be formed from plastic and have a white surface on its bottom side. Calibration strip 540 is attached to the top side of the scanner glass 102. Adhesive bead 508 is located along the front edge of calibration strip. Adhesive bead is chosen such that it has a small contact angle. The front edge of media (not shown) moving along the top surface of scanner glass towards media lift device 500 will contact adhesive bead and will be lifted off of the top surface of the scanner glass 102. The front edge of the media will then move across the calibration strip and be directed towards ADF output ramps 216 located behind the calibration strip 540. In other example embodiments of the invention, a calibration strip may be combined with adhesive dots or bumps to form a media lift device.

In the examples shown above, the media lift devices are attached to a single piece of scanner glass that is used for both the flatbed and ADF scans. In some scanners two different pieces of glass are used, one piece for ADF scans and one for flatbed scans. Some scanners are used in devices that do not have a flatbed scanning area. All scans are fed through an ADF. These types of scanners typically only have one piece of glass used for the ADF scan path. The media lift devices described above may be used on any type of scanner that feeds paper with an ADF.

What is claimed is:

1. A scanner, comprising:
a transparent scanning platen having a flat top surface, the transparent scanning platen having a scan area, the scan area positioned between a first side and a second side of the transparent scanning platen;
at least one media lift device adjacent the scan area and bonded to the top fiat surface, wherein each of the at least one media lift devices forms a raised area on the top of the flat surface and wets the transparent scanning platen.

2. The scanner of claim 1, further comprising:
an automatic document feeder (ADF) positioned above the scan area, the ADF having at least one rib extending down to the top flat surface of the transparent scanning platen, the at least one rib forming part of an output path of the ADF, the at least one rib having a tip, where a top surface of the tip is below a top surface of the at least one media lift device, the at least one rib positioned adjacent the at least one media lift device.

3. The scanner of claim 1, wherein the at least one media lift device is in the shape of one of the following shapes: a dot, a bump, a truncated sphere, or a bead.

4. The scanner of claim 1, wherein the at least one media lift device is formed from one of the materials in the following group: adhesive, epoxy, acrylic, glue or cyanoacrylate.

5. The scanner of claim 3, wherein the uncured viscosity of the material used in the media lift device is between 1000 and 5000 centipoise.

6. The scanner of claim 1, wherein the transparent scanning platen is a single piece of glass and is used for both ADF scans and flatbed scans.

7. The scanner of claim 1, wherein the transparent scanning platen is a single piece of glass and is only used for ADF scans.

8. The scanner of claim 1, wherein the at least one media lift device comprises:
at least one drop of a first adhesive having a first uncured viscosity and at least one drop of a second adhesive having a second uncured viscosity wherein the first uncured viscosity is greater than the second uncured viscosity and where the at least one drop of the second adhesive is placed at the juncture of the at least one drop of the first adhesive and the flat top surface of the transparent scanning platen.

9. The scanner of claim 1, wherein the at least one media lift device comprises:
a calibration strip adjacent the scan area and having a leading edge closest to the scan area;
at least one bead of adhesive running along the leading edge at the juncture of the leading edge of the calibration strip and the flat top surface of the transparent scanning platen where a height of the at least one bead of adhesive is greater than a height of the leading edge.

10. The scanner of claim 2, further comprising;
a plurality of media lift devices and a plurality of ribs extending down to the to flat surface of the transparent scanning platen, wherein at least one of the plurality of ribs is located between at least two of the plurality of media lift devices.

11. A method of manufacturing a media lift device, comprising:
placing at least one drop of adhesive on a top surface of a flat scanner glass adjacent to an ADF scan area, where the adhesive wets the top surface of the scanner glass;
curing the adhesive, wherein the cured adhesive forms a raised area on the top surface of the scanner glass.

12. The method of manufacturing a media lift device of claim 11, where the adhesive has an uncured viscosity between 1000 and 5000 centipoise.

13. The method of manufacturing a media lift device of claim 11, where the media lift device is in the shape of one of the following shapes: a dot, a bump, a truncated sphere, or a bead.

14. The method of manufacturing a media lift device of claim 11, further comprising:
mounting the flat scanner glass into a scanner, were the media lift device is located in the output path of an ADF when the ADP is mounted to the scanner.
